(19) United States
(12) Patent Application Publication
(10) Pub. No.: US 2004/0059604 A1
(43) Pub. Date: Mar. 25, 2004

(54) Patient medical parameter acquisition and distribution system

(76) Inventor: John R. Zaleski, West Brandywine, PA (US)

Correspondence Address: Alexander J. Burke, Intellectual Property Department, 5th Floor, 170 Wood Avenue South, Iselin, NJ, 08830, US

(21) Appl. No.: 10/629,034

(22) Filed: Jul. 28, 2003

Related U.S. Application Data
(60) Provisional application No. 60/399,338, filed on Jul. 29, 2002.
(60) Provisional application No. 60/399,282, filed on Jul. 29, 2002.

(51) Int. Cl. G06F 17/60

(52) U.S. Cl. 705/2

(57) ABSTRACT

A distribution system for patient medical parameters includes a communication interface, a data processor, and an output processor. The communication interface acquires patient parameters, at a user selectable receiving interval, in a first data format from patient monitoring devices attached to a multiple different patients. The data processor uses the communication interface for filtering acquired patient parameters for an individual patient to identify patient parameters meeting predetermined filtering criteria determinable by a user for an individual parameter type and for an individual patient, and excluding other patient parameters. The output processor converts the filtered identified parameters in the first data format to a different second data format, and uses the communication interface for output communication of the filtered identified patient parameters together with a parameter time and date of acquisition indication in the second data format.

### CROSS-REFERENCE TO RELATED APPLICATIONS

The present application is a non-provisional application of provisional application having serial No. 60/399,338 filed by John R. Zaleski on Jul. 29, 2002, and of provisional application having serial No. 60/399,282 filed by John R. Zaleski on Jul. 29, 2002.

### FIELD OF THE INVENTION

The present invention generally relates to information systems for healthcare applications. More particularly, the present invention relates to a patient medical parameter acquisition and distribution system.

### BACKGROUND OF THE INVENTION

In a healthcare information system, a server acquires and transmits a patient's vital signs file (e.g., *.vsf, where the asterisk implies the number corresponding to the particular patient). Existing software products addressing the patient's vital signs file included archiving capability while permitting fixed filtering of specific patient parameters for review within a display window. However, these products require mapping files that need to be changed in order to retrieve different data from the patient's vital signs file, or that need to be created and added. Further, the mapping files need to be specific to the details of the patient parameters selected by a user. Still further, the software products do not provide unsolicited outbound traffic capability.

In view of the foregoing, it would be desirable to provide a system and method that provides patient vital sign data to clinicians in a flexible, efficient, and cost effective manner. More specifically, it would be desirable to provide variable parameter frequency updates in real time, to permit active selection and de-selection parameters for interrogation from the server patient vital signs file, to provide patient vital signs files to non-compatible systems, to provide an interface to a clinical access server, and to provide a flexible and effective user interface. Accordingly, there is a need for a patient medical parameter acquisition and distribution system that overcomes these and other disadvantages of the prior systems.

### SUMMARY OF THE INVENTION

A distribution system for patient medical parameters includes a communication interface, a data processor, and an output processor. The communication interface acquires patient parameters, at a user selectable receiving interval, in a first data format from patient monitoring devices attached to a multiple different patients. The data processor uses the communication interface for filtering acquired patient parameters for an individual patient to identify patient parameters meeting predetermined filtering criteria determinable by a user for an individual parameter type and for an individual patient, and excluding other patient parameters. The output processor converts the filtered identified parameters in the first data format to a different second data format, and uses the communication interface for output communication of the filtered identified patient parameters together with a parameter time and date of acquisition indication in the second data format.

These and other aspects of the present invention are further described with reference to the following detailed description and the accompanying figures, wherein the same reference numbers are assigned to the same features or elements illustrated in different figures. Note that the figures may not be drawn to scale. Further, there may be other embodiments of the present invention explicitly or implicitly described in the specification that are not specifically illustrated in the figures and visa versa.

### BRIEF DESCRIPTION OF THE DRAWINGS

FIG. 1 illustrates a block diagram of a patient medical parameter acquisition and distribution system, in accordance with a preferred embodiment of the present invention.

FIG. 2 illustrates a flowchart describing a vital signs integration tool (VSIT) method for use with the system, as shown in FIG. 1, in accordance with a preferred embodiment of the present invention.

FIG. 3 illustrates a flowchart further describing the step for configuring the server, as shown in FIG. 1, according to the VSIT method, as shown in FIG. 2, in accordance with a preferred embodiment of the present invention.

FIG. 4 illustrates a flowchart further describing the step for identifying the data to be collected by the server, as shown in FIG. 1, according to the VSIT method, as shown in FIG. 2, in accordance with a preferred embodiment of the present invention.

FIG. 5 illustrates a flowchart further describing the step for configuring the client, as shown in FIG. 1, according to the VSIT method, as shown in FIG. 2, in accordance with a preferred embodiment of the present invention.

FIG. 6 illustrates a flowchart further describing the steps performed by the server, as shown in FIG. 1, responsive to the step of starting the server process, as shown in FIG. 3, in accordance with a preferred embodiment of the present invention.

FIG. 7 illustrates the graphical user interface (GUI) having the display used with the step of selecting various VSIT programs, as shown in FIG. 3, in accordance with a preferred embodiment of the present invention.

FIGS. 8, 9, 10, and 11 illustrate GUIs having the display windows used with the steps of configuring the server, as shown in FIG. 3, in accordance with a preferred embodiment of the present invention.

FIGS. 12 and 13 illustrate GUIs having the display windows used with the steps of identifying the data to be collected by the server, as shown in FIG. 4, in accordance with a preferred embodiment of the present invention.

FIGS. 14, 15, 16, and 17 illustrate GUIs having the display windows used with the steps of configuring the client, as shown in FIG. 5, in accordance with a preferred embodiment of the present invention.

FIGS. 18 and 19 illustrate GUIs having the display windows used with the steps of selecting filtering criteria for the parameter's data, as shown in FIG. 5, in accordance with a preferred embodiment of the present invention.

FIG. 20 illustrates the GUI having the display window used by a client, as shown in FIG. 1, providing clinical access to the patient's parameter data, provided by the VSIT method, as shown in FIG. 2, in accordance with a preferred embodiment of the present invention.

### DETAILED DESCRIPTION OF THE PREFERRED EMBODIMENTS

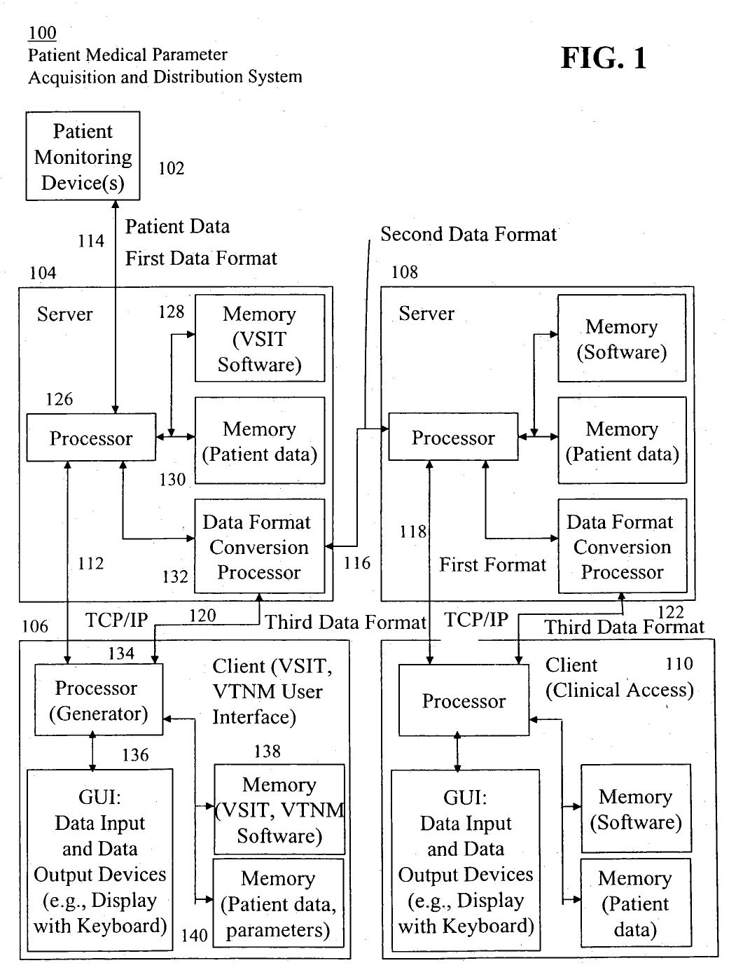

FIG. 1 illustrates a block diagram of a patient medical parameter acquisition and distribution system (hereinafter referred to as “the system”) 100, in accordance with a preferred embodiment of the present invention. The system 100 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a skilled nursing facility, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The system 100 generally includes at least one patient monitoring device 102, a server 104, a client 106, a server 108, and a client 110. Together, the server 104 and the client 106 preferably form a client/server computer architecture advantageously permitting the client 106 to be located remotely from the server 104, as is well known in the art. Alternatively, the server 104 and the client 106 may form an integral computer architecture requiring the client 106 and the server 104 to be located near one another, as is well known in the art. The server 108 and the client 110 are also designed in an analogous preferred and alternate manner as described for the server 104 and the client 106.

The client 106 communicates with the server 104 over a communication path 112 or over a communication path 120. The patient monitoring device 102 communicates with the server 104 over a communication path 114. The server 104 communicates with the server 108 over a communication path 116. The server 108 communicates with the client 110 over a communication path 118 or over a communication path 122. Each of the elements in FIG. 1 include communication interfaces for transmitting and/or receiving data over the six communication paths 112, 114, 116, 118, 120, and 122. Each of the six communication paths 112, 114, 116, 118, 120, and 122 may be unidirectional or bi-directional as so required or desired.

The six communication paths 112, 114, 116, 118, 120, and 122 may be the same or different communication paths, depending on the particular network configuration and the particular communication protocols implemented. Each of the six communication paths 112, 114, 116, 118, 120, and 122 may be implemented as a local area network (LAN), such as an intranet, or a wide area network (WAN), such as an Internet, or a combination thereof. Preferably, the communication path 112, the communication path 120, the communication path 118, and the communication path 122 are each WANs formed by the Internet.

Each of the communication paths are preferably adapted to use one or more data formats, otherwise called protocols, depending on the type and/or configuration of the various elements in the system 100. Examples of the information system data formats include, without limitation, an RS232 protocol, an Ethernet protocol, a Medical Interface Bus (MIB) compatible protocol, an Internet Protocol (IP) data format, a local area network (LAN) protocol, a wide area network (WAN) protocol, an IEEE bus compatible protocol, and a Health Level Seven (HL7) protocol.

Preferably, the communication path 112 uses an IP data format to permit the client 106 and the server 104 to communicate with each other using a common data format. Preferably, the communication path 118 also uses an IP data format to permit the client 110 and the server 108 to communicate with each other using a common data format. The I.P. data format, otherwise called an I.P. protocol, uses IP addresses. Examples of the I.P. addresses include, without limitation, Transmission Control Protocol Internet Protocol (TCP/IP) address, an I.P. address, a Universal Resource Locator (URL), and an electronic mail (Email) address.

Preferably, the communication path uses an RS232 protocol, an Ethernet protocol, or a Medical Interface Bus (MIB) compatible protocol. Preferably, the communication path 116 uses an IEEE bus compatible protocol or a Health Level Seven (HL7) protocol.

Each of the six communication paths 112, 114, 116, 118, 120, and 122 may be formed as a wired or wireless (W/WL) connection. Preferably, the communication paths are formed as a wired connection. In the case of a wired connection, the I.P. address is preferably assigned to a physical location of the termination point of the wire, otherwise called a jack. The jack is mounted in a fixed location near the location of the various elements of the system 100. In the case of a wireless connection, I.P. addresses are preferably assigned to the various elements, since some the various elements, such as the client 106, the client 110, and/or the patient monitoring device 102, would be mobile. The wireless connection permits the person using the system 100 to be mobile beyond the distance permitted with the wired connection.

The server 104 further includes a processor 126, a memory 128, a memory 130, and a data format conversion processor (hereinafter referred to as “the conversion processor”) 132 (otherwise referred to as an output processor). The server 108 also includes a processor, a first memory, a second memory, and a data format conversion processor, and is constructed and operates in a similar manner to the server 104.

The processor 126, otherwise called a data processor, manages the communications between the server 104 and the patient monitoring device 102, manages the communications between the server 104 and the client device 106, and manages the communications between the server 104 and the server 108. The processor 126 may be implemented in software and/or hardware and operates responsive to the software program stored in the memory 128.

The conversion processor 132 converts the patient data between a first data format and a second, different, data format, and/or between the first data format and a third data format, different from the first or second data format. Each of the data formats may be of any type, including, without limitation, those described herein.

In the server 104, the memory 128 stores VSIT software described herein, and the memory 130 stores patient data files described herein. Preferably, the memory 128 that holds the VSIT software is implemented in read only memory (ROM), or other suitable memory unit that runs a predetermined software program while the server 104 is in use. Preferably, the memory 130 that stores the patient data files is implemented in random access memory (RAM), or other suitable memory unit that can be refreshed, cached, or updated while the server 104 is in use. The server 104 is preferably implemented as a personal computer or a workstation.

The patient data files, otherwise called a patient medical record repository, stored in the memory 130 generally include any information related to a patient's health and welfare, and preferably include any information related to a patient's vital signs. Examples of patient data related to a patient's health and welfare include, without limitation, biographical, financial, clinical, workflow, and care plan information. Examples of patient data related to a patient's vital signs include, without limitation, a patient's heart rate, respiratory rate, blood oxygen saturation indicator, ventilation related data indicator, and an anatomical electrical activity indicator. Presently, there are up to three hundred twenty potential patient vital signs that can be monitored. Corresponding patient monitoring devices 102 for one or more patients monitors the various patient vital signs.

The patient data files stored in the memory 130 may be represented in a variety of file formats including, without limitation and in any combination, numeric files, text files such as documents, graphic files such as a graphical trace including, for example, an electrocardiogram (EKG) trace, an electrocardiogram (ECG) trace, and an electroencephalogram (EEG) trace, video files such as a still video image or a video image sequence, an audio file such as an audio sound or an audio segment, and visual files, such as a diagnostic image including, for example, a magnetic resonance image (MRI), an x-ray, a positive emission tomography (PET) scan, or a sonogram.

The patient data files stored in the memory 130 are an organized collection of clinical information concerning one patient's relationship to a healthcare enterprise (e.g. region, hospital, clinic, or department). Hence, the history of the patient's care by the healthcare providers in the healthcare enterprise may be represented in the patient data files.

The client 106 further includes a processor 134 (otherwise referred to as a generator), a graphical user interface (GUI) 136, a memory 138, and a memory 140, and generally are connected to each other, as shown in FIG. 1, to operate in a manner well known to those skilled in the art of client devices. The client 110 also includes a processor, a GUI, a first memory, and a second memory, and is constructed and operates in a similar manner to the client 106. The GUI 136 generally includes an input device and an output device. Preferably, the memory 138 stores VSIT software described herein, and the memory 140 stores the list of patient parameters described herein. The client 106 is preferably implemented as a personal computer. The personal computer may be fixed or mobile and may be implemented in a variety of forms including, without limitation, a desktop, a laptop, a personal digital assistant (PDA), and a cellular telephone.

In particular, the GUI 136 of the client 106 generally includes an input device that permits a user to input information into the client 106 and an output device that permits a user to receive information from the client 106. Preferably, the input device is a keyboard, but also may be a touch screen, a microphone with a voice recognition program, for example. Preferably, the output device is a display, but also may be a speaker, for example. The output device provides information to the user responsive to the input device receiving information from the user or responsive to other activity by the client 106. For example, the display presents information responsive to the user entering information in the client 106 via the keypad, as shown in some of the figures herein. Preferably, a web browser forms a part of each of the input device and the output device by permitting information to be entered into the web browser and by permitting information to be displayed by the web browser, as shown in some of the figures herein. Many different GUI techniques for inputting data and outputting data, preferably using a browser interface, may be implemented for efficiency and ease of use including, without limitation, selection lists, selection icons, selection indicators, drop down menus, entry boxes, slide bars, search queries, hypertext links, Boolean logic, template fields, natural language, stored predetermined queries, system feedback, and system prompts. The server 104 may also have a GUI, having an input device and an output device, which operates in the same or different way than the GUI 136 of the client 106.

The client 110 represents healthcare sources, otherwise known as individual systems themselves, which need access to patient's information, such as a patient's clinical information. Examples of the healthcare sources include, without limitation, a hospital system, a medical system, and a physician system, a records system, a radiology system, an accounting system, a billing system, and any other system required or desired in a healthcare information system. The hospital system further may include, without limitation, a lab system, a pharmacy system, a financial system, and a nursing system. The medical system represents a healthcare clinic or another hospital system. The physician system represents a physician's office. Typically, the systems in the hospital system are physically located within the same facility or on the same geographic campus. However, the medical system and the physician system are each typically located in a different facility at a different geographic location. Hence, the healthcare sources represent multiple, different healthcare sources that need access to patient information and that may have various physical and geographic locations.

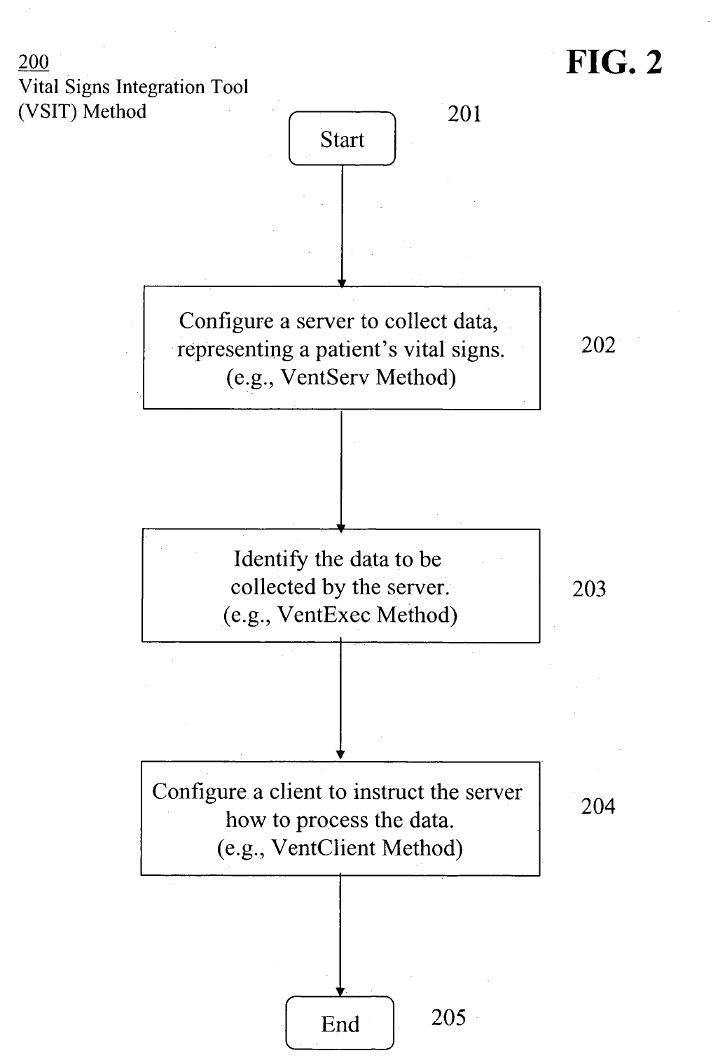

Generally, under typical operating conditions, the client 106 selects and configures patient parameters that are sent to the server 104 via the communication path 112. The server 104 sends a query to the patient monitoring device 102 and/or receives patient data via the communication path 114 responsive to receiving the configured patient parameters from the client 106. The patient monitoring device 102 sends patient data to the server 104 via the communication path 114 either automatically or responsive to receiving the query from the server 104. The server 104 processes the received patient data and sends the processed patient data to the client 106 via the communication path 112 and/or to the client 110 via the server 108 responsive to receiving the patient data from the patient monitoring device 102. Hence, the server 104 receives and processes patient data from the patient monitoring device 102 responsive to patent parameter criteria received from the client 106, and transmits the processed patient information to the client 106 and/or the client 110. Further details related to the method of operation of the patient monitoring device 102, the client 106, the server 104, the client 110, and the server 108, are described with reference to FIGS. 2-20.

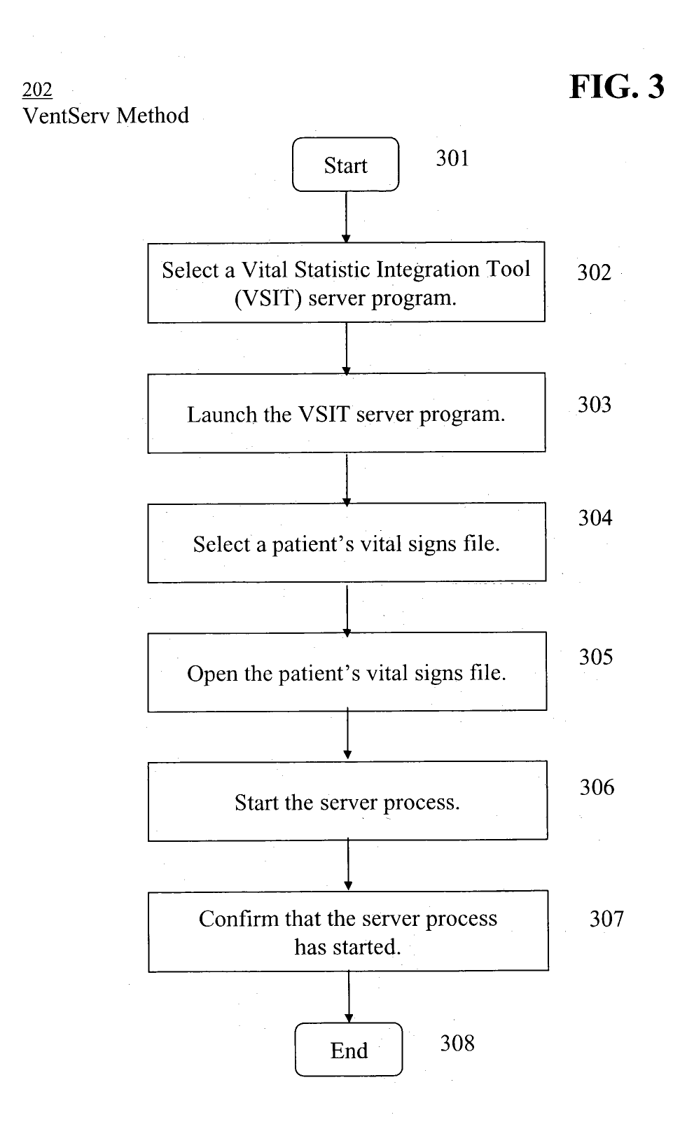

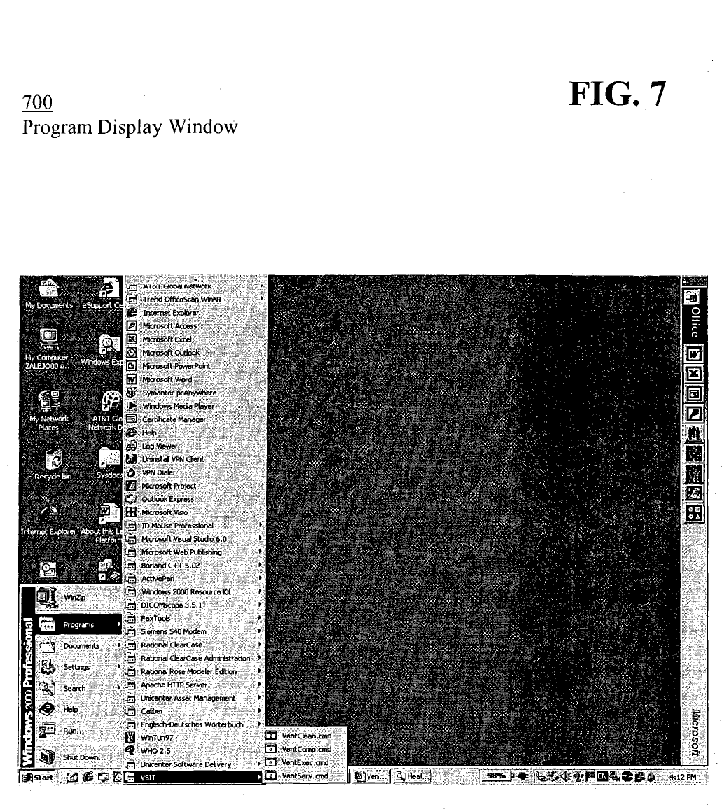

FIG. 2 illustrates a flowchart describing a vital signs integration tool (VSIT) method 200 for use with the system 100, as shown in FIG. 1, in accordance with a preferred embodiment of the present invention. Preferably, the method 200 is performed by the client 106 responsive to the VSIT software program stored in the memory 138 of the client 106. Preferably, only a system administrator uses the client 106 to engage the method 200, but, alternatively, a clinical user may be permitted to do the same, depending on the procedures and policies of the healthcare enterprise. The method 200 generally includes three steps, preferably called the VentServ method 202, the VentExec method 203, and the VentClient method 204 represented by three specific executable command files: VentServer.cmd file, the VentExec.cmd file, and the VentClient.cmd file, respectively. As shown in FIG. 7, each of the three methods 202, 203, and 204 may be selected and launched from a “Programs” task menu, as is well known to those skilled in the art of personal computer software. Preferably, the administrator beneficially interacts with preprogrammed command files, such as the three methods 202, 203, and 204, so that the administrator does not have to use cumbersome MS-DOS command prompts. Although the steps in FIG. 2 and the expanded steps shown in FIGS. 3, 4, and 5 are written from the perspective of the administrator, analogous steps may be implied from the perspective of the client 106.

At step 201, the method 200 starts.

At step 202, the administrator configures the server 104 to collect patient data, representing a patient's vital signs (e.g., VentServ method), as further described in FIG. 3, responsive to the administrator's inputs.

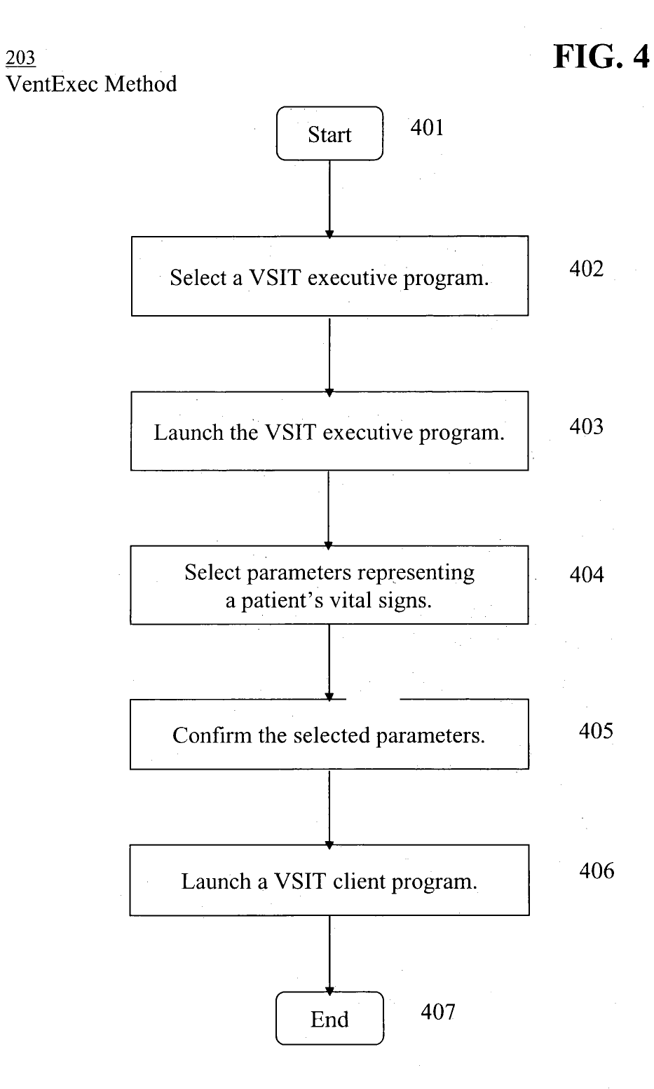

At step 203, the administrator identifies the patient data to be collected by the server 104 (e.g., VentExec method), as further described in FIG. 4, responsive to the administrator's inputs.

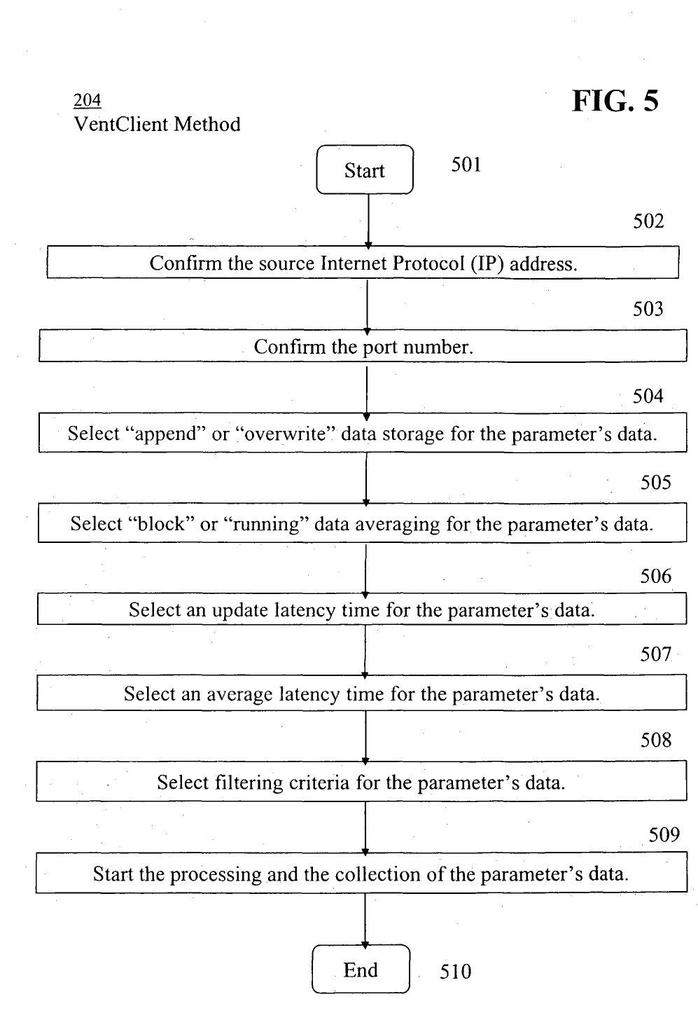

At step 204, the administrator configures the client 106 to instruct the server 104 how to collect and process the patient data (e.g., VentClient method), as further described in FIG. 5, responsive to the administrator's inputs.

At step 205, the method 200 ends.

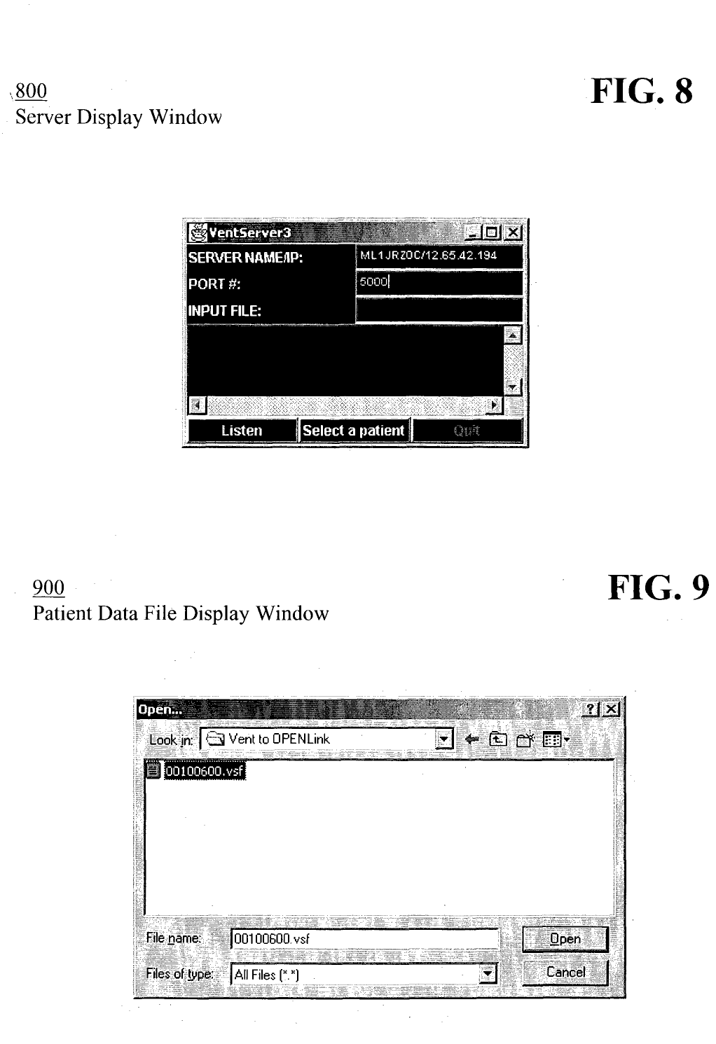

FIG. 3 illustrates a flowchart further describing the step for configuring 202 the server 104, as shown in FIG. 1, according to the VSIT method 200, as shown in FIG. 2, in accordance with a preferred embodiment of the present invention. In FIG. 3, the step for configuring 202 is otherwise described as the VentServ method. The method 202 in FIG. 3 is described in combination with the GUI having a display as shown in FIGS. 7, 8, 9, 10, and 11. In particular, FIG. 7 illustrates the GUI having the display 700 used with the step of selecting the various VSIT programs, as shown in FIG. 3, in accordance with a preferred embodiment of the present invention. In particular, FIGS. 8, 9, 10, and 11 illustrate GUIs having the display windows 800, 900, 1000, and 1100, respectively, used with the steps of configuring the server, as shown in FIG. 3, in accordance with a preferred embodiment of the present invention.

At step 301, the method 202 starts.

At step 302, the administrator selects the VSIT server program by pulling up the “Programs” menu, then by selecting the VSIT program, then by selecting the VentServ.cmd program, as shown in FIG. 7.

At step 303, the administrator launches the VSIT server program responsive to selecting the VentServ.cmd program, as shown in FIG. 7, to bring up the server display window 800, as shown in FIG. 8. In FIG. 8, the default name and WP address for the server 104 are those displayed for the current server (e.g. “localhost”). The administrator can define a preferred port number for the server 104, or, alternatively, accept the default port number on which the server 104 will listen for interactive communication with the client 106. The text field for the input file is blank initially.

At step 304, the administrator selects the patient's vital signs file by clicking on the “Select a Patient” button in the server display window 800 in FIG. 8.

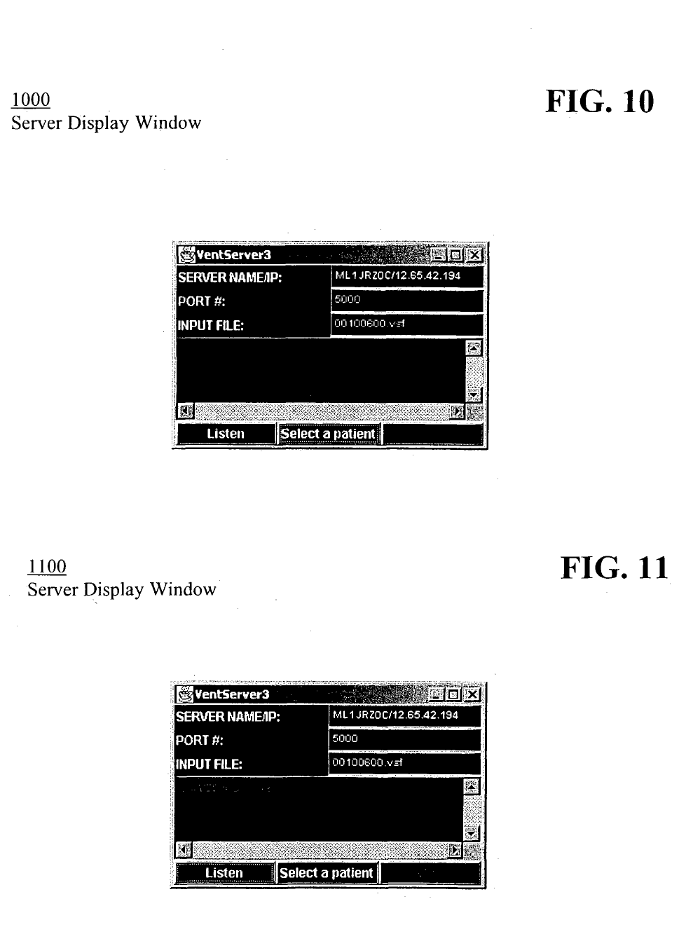

At step 305, the administrator opens the patient's vital signs file responsive to the selection of the patient's vital signs file in step 304. Preferably, the administrator manually selects a desired patient's vital signs file from a current directory shown in the display window 900. Automated or semi-automated selection methods may also be used. The default location for the patient's vital signs file is the current directory of the VSIT server process. However, the administrator can specify the patient's vital signs file from any directory location by navigating to that directory location in the directory structure. Upon selecting “Open” button in the display window 900 of FIG. 9, the administrator will be presented again with the server display window with the input file text field populated with the desired vital signs file, as shown in the server display window 1000 of FIG. 10.

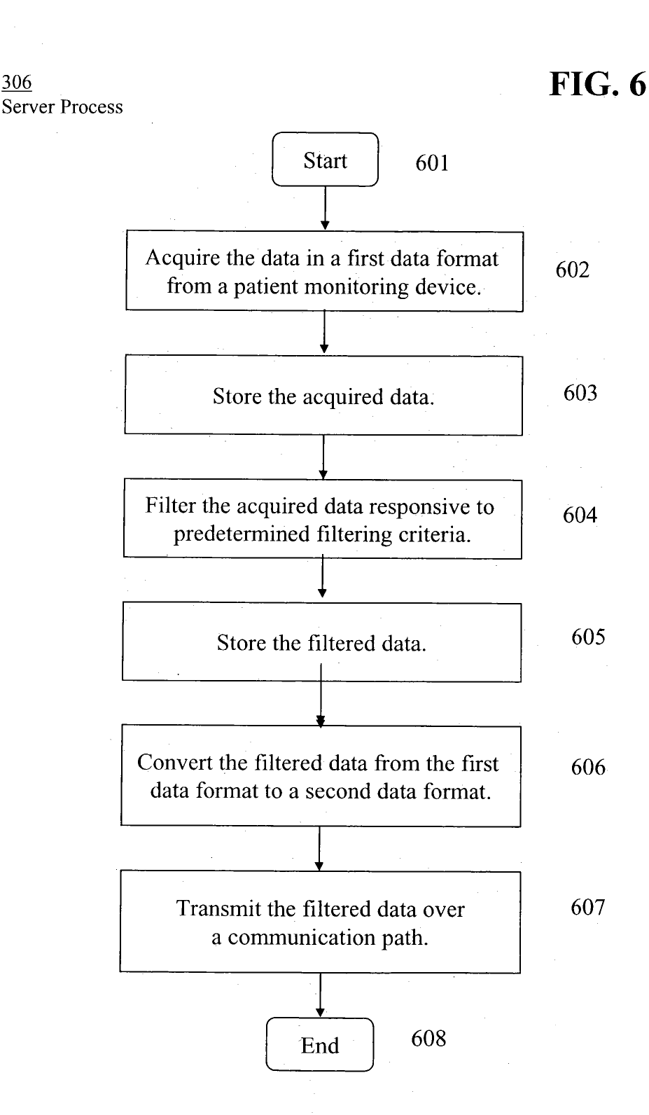

At step 306, the administrator starts the server process by pressing the “Listen” button in the server display window 1000 of FIG. 10. This causes the server 104 to listen on the selected port for the desired vital signs file. Further details about the server process from the server 104 point of view are shown and described herein with reference to FIG. 6.

At step 307, the administrator confirms that the server process has started by the message displayed in the server display window 1100, as shown in FIG. 11.

At step 308, the method 202 ends.

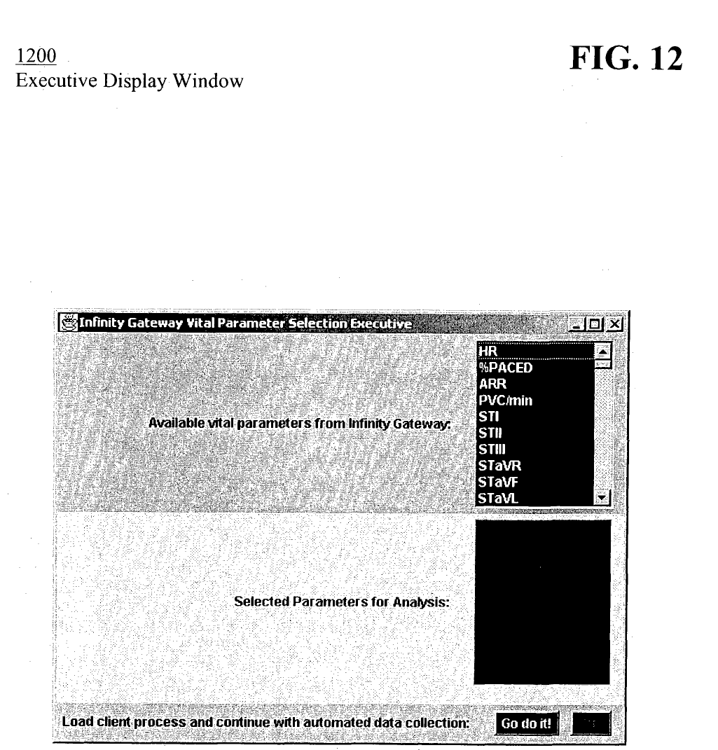

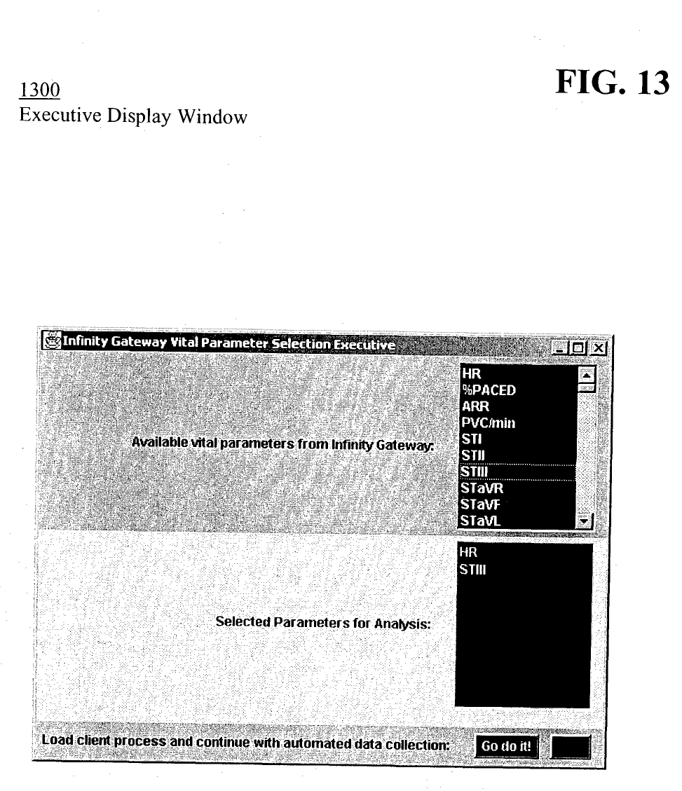

FIG. 4 illustrates a flowchart further describing the step for identifying 203 the data to be collected by the server 104, as shown in FIG. 1, according to the VSIT method 200, as shown in FIG. 2, in accordance with a preferred embodiment of the present invention. Preferably, the client 106 collects data from the server 104 through the TCP/IP requests on the established port. In FIG. 4, the step for identifying 203 is otherwise described as the VentExec method. The method 203 in FIG. 4 is described in combination with FIGS. 12 and 13 illustrating GUIs having the display windows 1200 and 1300, respectively, used with the steps of identifying 203 the data to be collected by the server, as shown in FIG. 4, in accordance with a preferred embodiment of the present invention.

At step 401, the method 203 starts.

At step 402, the administrator selects the VSIT executive program by pulling up the “Programs” menu, then by selecting the VSIT program, then by selecting the VentExec.cmd program, as shown in FIG. 7.

At step 403, the administrator launches the VSIT executive program responsive to selecting the VentExec.cmd program, as shown in FIG. 7, to bring up the server display window 1200, as shown in FIG. 12. The VentExec.cmd program creates a list of parameters that are drawn from a database, such as the memory 140, using a Java data base connection to an open data base connection (JDBC-to-ODBC) bridge, for example, as is well known to those skilled in the art of database design. The database includes, without limitation, MS Access, SQL Server, and Oracle databases. This collection of parameters represents the summary of values available from the server 104. Preferably, these parameters are stored within an MS Excel™ spreadsheet, and defined as a system data source name (DSN) called “exceltest” within the open data base connection (ODBC) manager. Preferably, the VentExec.cmd program links to this database using a Java™ program, via a ClassforName (“sunjdbc.odbc.JdbcOdbcDriver”) directive within the body of a buildUI method contained within the VentExec.cmd program. The parameters are read within the Java program and are assigned to a multi-dimensional array that captures the count of the parameters together with their specific values. The array is then added to a list object defined within the VentExec.cmd program.

At step 404, the administrator selects parameters representing the patient's vital signs by selecting one or more parameters from the list in the windowpane shown at the upper portion of the right hand side of the executive display window 1200 of FIG. 12. The method displays the selected parameters in the lower portion of the right hand side of the executive display window 1200 of FIG. 12 responsive to each-selection. The administrator deselects parameters by simply selecting the selected parameter again in the upper windowpane. The de-selection action removes the selected parameter from the lower windowpane, and, hence, from processing consideration by the server 104. Preferably, the patient parameters may be of any type including, without limitation, heart rate, respiratory rate, blood oxygen saturation indicator, ventilation related data indicator, and anatomical electrical activity indicator.

Preferably, in step 404 the VentExec.cmd program defines an ItemListener that listens for selections from this list, in which the administrator can specify one or more parameters via a mouse click. As parameters are selected via mouse click, they are made visible in a second list (e.g., immediately below the first list) by adding the selected parameters from list one to list two. Parameters can be deselected from list two by simply clicking on those same parameters within list one. The contents of list two are then written to a temporary file that is read directly by the VentClient program, and used to extract specific parameters from the content of the large vital signs file produced by the server 104.

At step 405, the administrator confirms the selected parameters by reviewing the selected parameters shown in the lower windowpane of the executive display window 1200 of FIG. 12.

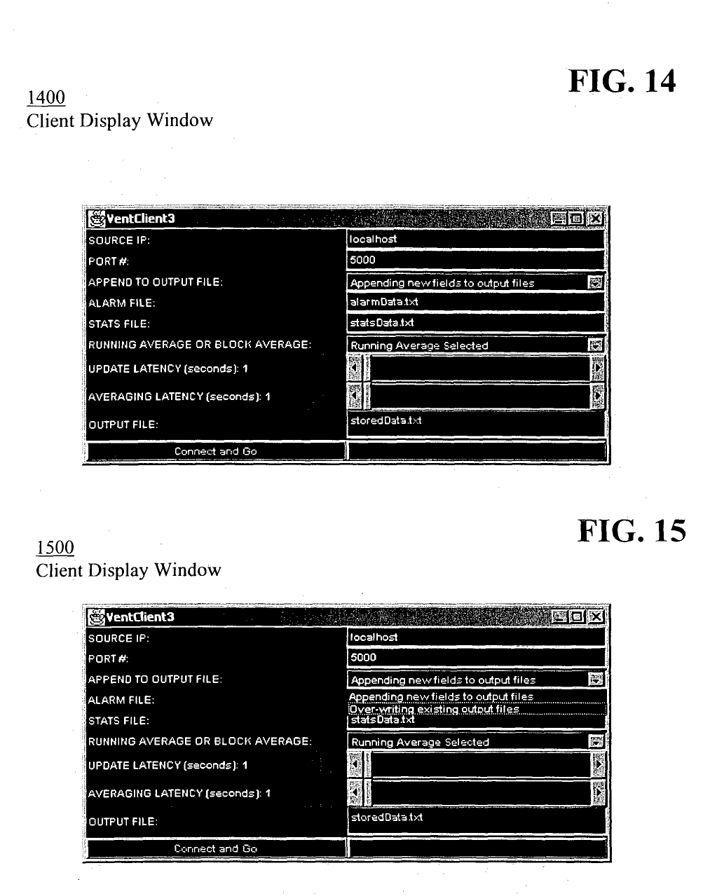

At step 406, the administrator launches the VSIT client program by pressing the “Go do it!” button in the executive display window 1200 of FIG. 12, preferably responsive to an ActionListener method associated with this button click. Alternatively, the administrator launches the VSIT client by the administrator pulling up the “Programs” menu, then by selecting the VSIT program, then by selecting the VentClient.cmd program, as shown in FIG. 7. Launching the VSIT client program brings up the client display window 1400 of FIG. 14.

At step 407, the method 203 ends.

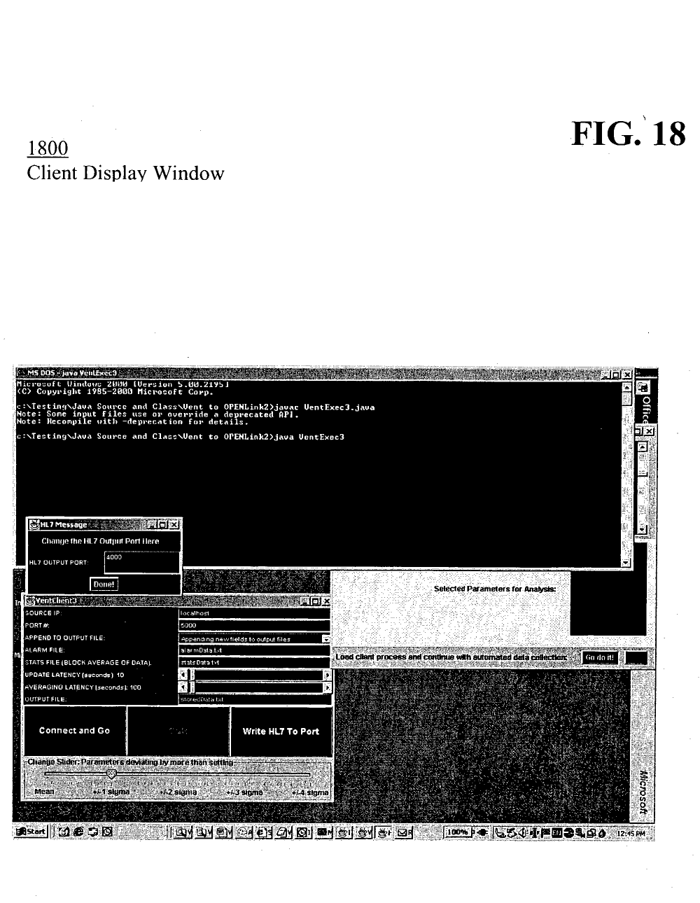

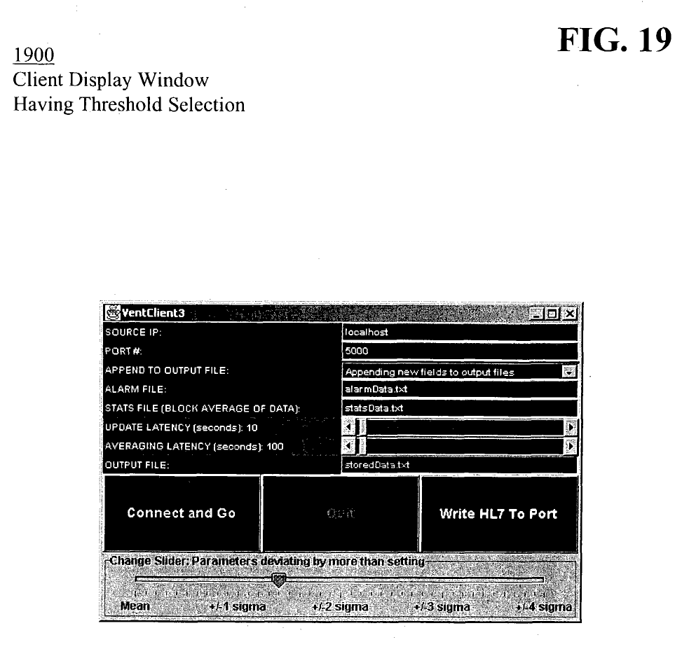

FIG. 5 illustrates a flowchart further describing the step for configuring 204 the client 106, as shown in FIG. 1, according to the VSIT method 200, as shown in FIG. 2, in accordance with a preferred embodiment of the present invention. In FIG. 5, the step for configuring 204 is otherwise described as the VentClient method. The method 204 in FIG. 5 is described in combination with FIGS. 14, 15, 16, 17, 18, and 19. In particular, FIGS. 14, 15, 16, and 17 illustrate GUIs having the display windows 1400, 1500, 1600, and 1700, respectively, used with the steps of configuring the client, as shown in FIG. 5, in accordance with a preferred embodiment of the present invention. FIGS. 14, 15, 16, and 17 illustrate GUIs having the display windows 1400, 1500, 1600, and 1700, respectively, represent the same display window and generally have several fields that define the source port and frequency of collection, as well as some selections regarding various types of data analysis. These statistics are reported for each parameter selected by the administrator in the VSIT executive program. In particular, FIGS. 18 and 19 illustrate GUIs having the display windows 1800 and 1900, respectively, used with the steps of selecting filtering criteria for the parameter's data, as shown in FIG. 5, in accordance with a preferred embodiment of the present invention.

Generally, the VentClient method accepts the parameters described earlier through the interface of the client 106 and launches a server connection thread to the server 104 that begins to poll the server port defined in the graphical user interface input field. This polling causes specific data to be drawn from the VentServer method. The specific data queries are defined by the nature of the input file created by the VentExec method. This input file (“InitialClientParms.txt”) retrieves the parameters specified by the user in the VentExec list windows. These parameters are stored in an array locally within the VentClient method where they are sent as data requests through the TCP/IP connection to the VentServer method. The VentServer method responds with the specific values associated with these requested parameters by the VentClient method and then the VentClient method stores and processes the parameter values. Averages are computed, and values are written either individually to the output files or as an ensemble. The client polls the server for these parameter values at user-defined intervals that are variable based on the slider setting of the client user interface window.

At step 501, the method 204 starts.

At step 502, the administrator confirms the source Internet Protocol (IP) address in the client display window 1400 of FIG. 14. The source IP is typically the machine on which the administrator is currently running. If the client and executive programs are running on the same machine as the VSIT server, then the source IP is the address of this machine, otherwise called a “localhost.” The port number must be the same as that previously specified for the server 104. This is the communication link by which the client 106 communicates with the server 104.

At step 503, the administrator confirms the port number in the client display window 1400 of FIG. 14.

At step 504, the administrator selects “append” or “overwrite” data storage for the parameter's data. Step 504 establishes whether the data from the patient's vital signs file are to be stored continuously (labeled as “Appending new fields.”) or are to be over-written (labeled as “Over-writing existing output . . . ”), as shown in the client display window 1500 of FIG. 15. Preferably, the administrator's selection applies to the outcome of all of the vital statistic data files (e.g., raw data files, statistical data files, or alarm data files), but may alternatively be applied to individual file types, if desired. The critical alarm data defined within the vital signs data file are stored within the file associated with the alarm file text field. The averages over blocks of vital signs data are stored in a data file specified within the stats file text field.

Note that in prior systems, servers wrote the vital signs file at each time interval established by the administrator (from intervals of 15 seconds up to 6000 seconds). At each interval, the existing vital signs file was over-written. If the information contained within the file is not stored, then it is lost forever. Thus, if the administrator desires to capture a collection of vital sign data for archival, analysis, or other warehousing purposes, then it is necessary to collect and store it. Data collection and storage was possible using a complimentary tool. However, if the user did not have the complimentary tool present within the server network (i.e., the administrator did not purchase and install the tool), then the present VSIT program provides a convenient way to collect and archive the selected parameters specified by the administrator into a file that is then updated continuously.

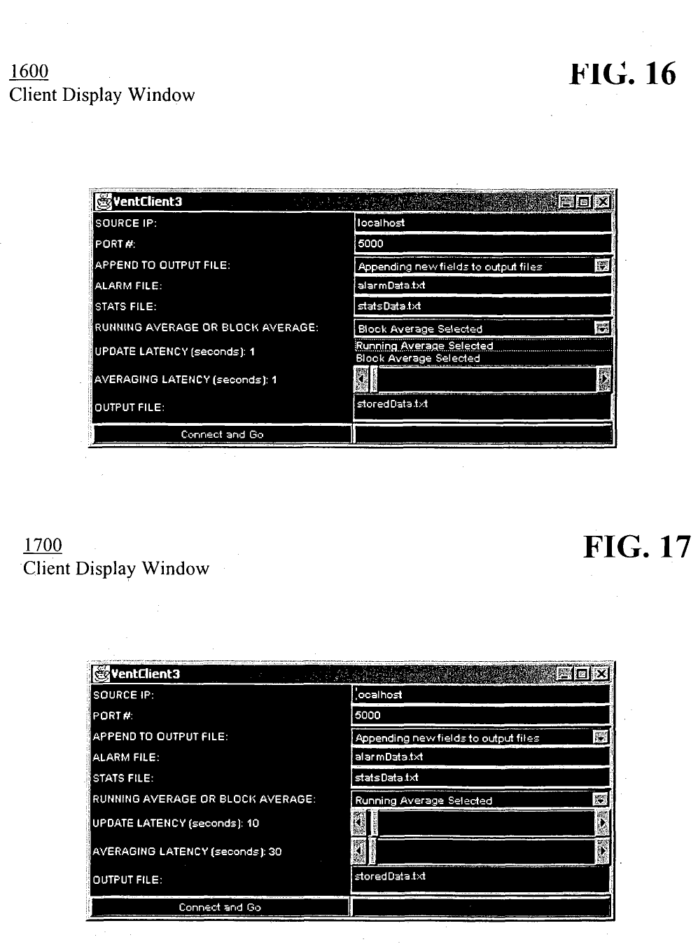

At step 505, the administrator selects “block” or “running” data averaging for the parameter's data from a drop down menu in the client display window 1600 of FIG. 16. Block averaging means that an average of a specified amount (or number) of data points is performed, and the resultant average is written to an output file specified by the stats file field. In block averaging, once a sample of data are collected that meet the specified criteria for quantity of data (in this case, specified by the averaging latency slider (i.e., the amount of time over which the data samples are averaged)), then the average value of the data points are calculated, reported to the stats file, and discarded. Averaging begins again on a new set of data, commencing with the data point collected immediately after the last data point of the previous block or averaging interval.

Running averaging means that the data points are collected as before, with an average being reported once the requisite data have been collected (again, as measured by the averaging latency slider). This time, however, after reporting on the average in the stats file, the first data point in the collected block is discarded. Once another (i.e., new) data point is collected to replace the discarded data point (and thereby meet the requisite data quantity as specified by the averaging latency slider), a new average is reported. Hence, the running average produces output data more often representative of the new average computed based on the inclusion of new data points each time they are collected.

At step 506, the administrator selects an update latency time for the parameter's data by moving the update latency slider, as shown in the client display window 1700 of FIG. 17. The update latency time represents the time between subsequent calls to the server 104 for updates to the patient's vital signs file. The update latency time is displayed numerically next to the update latency field description responsive to the administrator moving the update latency slider.

At step 507, the administrator selects an average latency time for the parameter's data by moving the average latency slider, as shown in the client display window 1700 of FIG. 17. The average latency time is displayed numerically next to the average latency field description responsive to the administrator moving the average latency slider. Preferably, the averaging latency time is at a minimum equal to the update latency time. Preferably, the averaging latency time can be varied from this minimum time value (i.e., greater than or equal to the update latency time) to a value of several thousand seconds. For example, the client display window 1700 of FIG. 17 shows the update latency time set at ten (10) seconds with the averaging latency time set at thirty (30) seconds. This implies that an average will begin being computed once three data points are collected. Further, by example, since the running average alternative is selected, each time a new data point is collected beyond this, a new average value will be reported.

At step 508, the administrator selects filtering criteria for the parameter's data. Patient parameter values from the vital signs file are extracted periodically and sent to the Vital Threshold Notification Method (VTNM). FIG. 18 illustrates a graphical selection of the HL7 output port window using the VTNM. The VSIT tool permits the user to extract specific parameter values where a selected subset of these parameters is filtered from the global set available from the patient-monitoring device 102. This parameter filtration process enables the administrator to collect, analyze, and change any parameter in real-time while the tool is actively collecting patient data. Then, the VTNM calculates the sample mean and standard deviation on a user-specified number of measurements of these parameters. The sample mean is statistically compared (preferably, subtracted from) with the latest (e.g., current) measurement, using a distance measure specified according to the following formula, and compared with the user-defined alert threshold.

Distance=(Xᵢ−M)²/S²

Wherein:

M=Sample mean=Summation over Xi/N, and

S=Sample variance=Summation over (Xᵢ−M)²/(N−1), and

X=Latest measurement.

If the Distance measure exceeds the Threshold value, then an HL7 message is transmitted to the clinical access server 108 where it is stored according to patient identification (ID) and is made available for viewing by the clinical access web viewer at the client 110. The distance measure shown above measures the relative deviation between the current measurement and the sample values collected in terms of the sample deviation (i.e., with respect to the N-sigma sample standard deviation). The VTNM calculation described in step 508 is embodied in and represented as a sliding bar, otherwise called a slider, in the client display window 1900 of FIG. 19. The slider is simply moved left or right along the bar by the administrator to adjust the sensitivity of the data acquisition. The slider in the client display window 1900 of FIG. 19 defines the relative sensitivity to change in terms of the relative deviation of the newest measurement with respect to the sample variance. In normal or Gaussian statistical distributions in one dimension, values typically reside within 1-sigma (i.e., 1-sample standard deviation of the mean) approximately 67% of the time; within 2-sigma approximately 95% of the time; and within 3-sigma approximately 99% of the time. Hence, by the administrator selecting the appropriate value of slider, it is possible to increase or decrease the sensitivity to parameter variability. For example, by increasing the value of the slider, relatively large changes are required between the input data and the statistical mean before a change is identified as being significant by the VTNM to cause a message to be sent to clinical access server 108. On the other hand, if the change slider is set to approach zero, this implies that slight deviations between the mean and the latest measurement value cause messages to be sent to clinical access server 108.

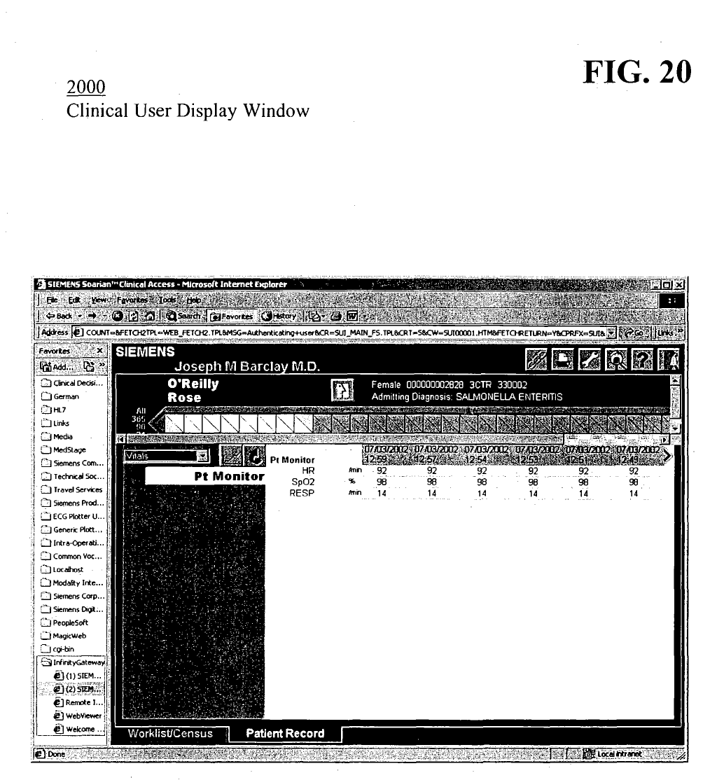

FIG. 20 illustrates the GUI having the display window 2000 used by the client 108, as shown in FIG. 1, providing clinical access by a clinical user to the patient's parameter data, provided by the VTNM, as shown in FIG. 2, in accordance with a preferred embodiment of the present invention. FIG. 20 illustrates a vital signs tab view for a particular patient showing three of the parameters transmitted from VTNM to the clinical access server 108.

Preferably, the VTNM is written in Java. The following code segment shows an example of the code used to write the HL7 format to the communication path 116 so that the clinical access server 108 can correctly interpret the code.

| | |
|---|---|
| Year | = tempArray[ 12 ].substring( 0, 4 ); |
| Month | = tempArray[ 12 ].substring( 5, 7 ); |
| Day | = tempArray[ 12 ].substring( 8, 10 ); |
| Hour | = tempArray[ 12 ].substring( 10, 12 ); |
| Minute | = tempArray[ 12 ].substring( 13, 15 ); |
| Second | = tempArray[ 12 ].substring( 16, 18 ); |

//*** MSH SEGMENT

outputToSocket.print( “\013MSH| [symbol] ˜\\&|Infinity||NUR||” +

Year + Month + Day + Hour + Minute +
“||ORU [symbol] R01|” +
Year + Month + Day + Hour + Minute +
“|P|2.3” + “\015” );

//*** PID SEGMENT

outputToSocket.print( “PID|||” + tempArray[ 1 ] +

“ [symbol] [symbol] [symbol] [symbol] ExternalPatientID||” +
tempArray[ 0 ] +
“|||||||||||” +
tempArray[ 1 ] + ““\015” );

//*** OBR SEGMENT

outputToSocket.print( “OBR|||||||” +

Year + Month + Day + Hour + Minute + “\015” );

//*** OBX SEGMENT

//
// NOTE: CHECK TO SEE WHICH CODES EXIST IN FOLLOWING ORDER.
//
// 1) LOINC 2) MIB/CEN 3) SIEMENS

//
// WRITE THE CODE VALUE, CODE NAME, AND CODE UNITS ASSOCIATED
// WITH THE EXISTING CODE TO THE HL7 MESSAGE
//
if( !tempArray[ 14 ].equals ( “NO_CURRENT_ENTRY” ) )
{

parmCode = tempArray[ 14 ];
parmUnits = tempArray[ 20 ];
outputToSocket.print( “OBX||SN|” +

tempArray[ 10 ] +
“ [symbol] [symbol] local [symbol] ” +
parmCode +
“\\&1 [symbol] [symbol] LOINC||” +
tempArray[ 11 ] +
“|” +
parmUnits +
“ [symbol] [symbol] ISO+|||||R|||” +
Year + Month + Day + Hour + Minute +
“\015” + “\034” + “\015” );

}
if ( tempArray[ 14 ].equals( “NO_CURRENT_ENTRY” ) )
{

if ( !tempArray[ 15 ].equals( “NO_CURRENT_ENTRY” ) )
{

parmCode = tempArray[ 15 ];
parmUnits = tempArray[ 21 ];
outputToSocket.print( “OBX||SN|” +

tempArray[ 10 ] +
“ [symbol] [symbol] local [symbol] ” +
parmCode +
“\\&1 [symbol] [symbol] LOINC||” +
tempArray[ 11 ] +
“|” +
parmUnits +
“ [symbol] [symbol] ISO+|||||R|||” +
Year + Month + Day + Hour + Minute +
“\015” + “\034” + “\015” );

} else {

parmCode = tempArray[ 13 ];
parmUnits = tempArray[ 19 ];
outputToSocket.print( “OBX||SN|” +

tempArray[ 10 ] +
“ [symbol] [symbol] local [symbol] ” +
parmCode +
“\\&1 [symbol] [symbol] LOINC||” +
tempArray[ 11 ] +
“|” +
parmUnits +
“ [symbol] [symbol] ISO+|||||R|||” +
Year + Month + Day + Hour + Minute +
“\015” + “\034” + “\015” );

} // END IF VALID CURRENT ENTRY

} // END IF NO CURRENT ENTRY

At step 509, the administrator starts the collection and processing of the parameter's data by clicking the “Connect and Go” button in the client display window 1700 of FIG. 17. During the process, the administrator may beneficially change various fields in the various display windows shown herein in real time, without restarting the process, resulting in significant improvements in flexibility, efficiency, and ease of use. For example, the administrator can change the update frequency, the averaging latency, and even the names of files in real time, while data are being collected and processed, without restarting the process.

Responsive to starting the processing, the following files are produced: alarm, stats, output (stored data), as shown in the following examples.

alarmData.txt:

|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
|SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|1298|1
|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
|SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|1298|1
|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1

statsData.txt:

PID SEGMENT: SimulatedPatientData NO_CURRENT_ENTRY BED1 2002/05/2907:55:14 HR
AVERAGE VALUE: 83.0
NUMBER OF SAMPLES: 10
PID SEGMENT: SimulatedPatientData NO_CURRENT_ENTRY BED1 2002/05/2907:55:14 STIII
AVERAGE VALUE: 0.10000000149011612
NUMBER OF SAMPLES: 10
PID SEGMENT: SimulatedPatientData NO_CURRENT_ENTRY BED1 2002/05/2907:55:14 HR
AVERAGE VALUE: 83.0
NUMBER OF SAMPLES: 10
PID SEGMENT: SimulatedPatientData NO_CURRENT_ENTRY BED1 2002/05/2907:55:14 STIII
AVERAGE VALUE: 0.10000000149011612
NUMBER OF SAMPLES: 10
PID SEGMENT: SimulatedPatientData NO_CURRENT_ENTRY BED1 2002/05/2907:55:14 HR
AVERAGE VALUE: 83.0
NUMBER OF SAMPLES: 10

storedData.txt:

|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
|SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|1298|1
|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
|SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|12981|1
SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|1298|1
|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1
|SimulatedPatientData|NO_CURRENT_ENTRY|BED1|CCU1|00100600|INACTIVE|SER|NO_CURR
ENT_ENTRY|1984/01/28|03:42:18|STIII|0.1|2002/05/2907:55:14|01059|10123-
8|14653|NONE|NO_CURRENT_ENTRY|NO_CURRENT_ENTRY|mm|mm|1298|1
|SimulatedPatientData|NO_CURRENT_ENTRY|BED1|CCU1|00100600|INACTIVE|SER|NO_CURR
ENT_ENTRY|1984/01/28|03:42:18|HR|83|2002/05/2907:55:14|01001|8867-
4|16770|NONE|NO_CURRENT_ENTRY|NO_CURRENT_ENTRY|bpm|/min|2528|1

At step 510, the method 204 ends.

FIG. 6 illustrates a flowchart further describing the steps performed by the server, as shown in FIG. 1, responsive to the step of starting the server process, as shown in FIG. 3, in accordance with a preferred embodiment of the present invention. Generally, the VentServer method listens for requests from the VentClient method. When the VentClient method sends a query for a specific parameter to the VentServer method, the VentServer method opens the vital signs file prescribed within its user interface window, reads all data within the file, and stores those data within an array.

The VentServer method then filters out those data associated with the client's request from the totality of data contained within the vital signs data, and sends the resultant values back to the client via the port specified for handshaking between the client 106 and server 104.

At step 601, the method 306 starts.

At step 602, the server 104 acquires the data in a first data format from a patient monitoring device 102. The first data format may be any data format described herein. Preferably, the data processor 126 in the server 104 acquires the patient parameters at a user selectable acquisition-receiving interval selectable by a user for an individual parameter type and an individual patient At step 603, the server 104 stores the acquired data in the memory 130.

At step 604, the server 104 filters the acquired data responsive to predetermined filtering criteria. Preferably, the administrator selects the criteria using the client 106, according to the methods and graphical user interfaces described herein.

At step 605, the server 104 stores the filtered data in the memory 130.

At step 606, the server 104 converts the filtered data from the first data format to a second data format. The second data format may be any data format described herein. The conversion processor 132 performs the conversion process. Alternatively, the conversion processor 132 may convert the filtered data from the first data format to a third data format that is different from the first data format or the second data format. The third data format may be any data format described herein.

At step 607, the server 104 transmits the filtered data over a communication path, such as communication path 116 or 120. Preferably, a communication interface in the server 104 communicates the filtered identified patient parameters together with a parameter time and date of acquisition indication and associated predetermined filter criteria in the second data format to a storage file. Preferably, the storage file is associated with one or more of: a patient medical record repository, a patient electronic record, an alarm file, a raw data file and, a statistic compilation file. Preferably, the conversion processor 132 communicates data to the storage file based on identified data type. Preferably, the conversion processor 132 uses the communication interface for output communication of the filtered identified patient parameters together with appended data including one or more of: a patient identifier, a patient bed identifier, a hospital unit identifier, a parameter name, a parameter type, and an associated medical condition code set identifier.

At step 608, the method 306 ends.

The VSIT methods described herein provide at least the following benefits:

1. A client/server based set of methods for extracting real-time data from a server 104, filtering specific parameters, formatting and performing statistics on those parameters, and providing those parameters to an interface engine, preferably in an HL7 format for transmission to an electronic patient record. Hence, there is no need to configure fixed mapping files, as performed previously.

2. A graphical user interface (GUI) based variable data selection process that provides administrators with the ability to alter the frequency of data collection in real-time, and to alter the specific parameter selections, without changing the contents of mapping files. Hence, the VSIT methods can be ported from computer to computer, without requiring re-compilation or configuration of files, since all of the work is performed within the body of the software programs.

3. A graphically based means of performing data averaging on any parameters selected from the server without requiring installation of additional software tools to read the vital signs information from the server 104.

4. A method for reading the vital signs data and accumulating it at regular intervals for future archiving and analysis, without requiring changes to the server 104, or the vital signs file normally produced by the server 104. These data can be segregated according to parameters, patient identifiers, time, or any other parameters or identified by the administrator.

5. The VSIT software is relatively straightforward, written in Java (therefore, byte code is portable), permitting the software to consume little system resources in terms of CPU, disk space, and memory.

Preferably, these VSIT methods are advantageously extended directly to any field requiring real-time extraction and filtering of data, including telecommunications and computer system performance management. Preferably, the VSIT methods are delivered as ancillary software as part of the server software package, as an adjunct to a clinical data access software package, or as separate analysis software for teaching hospitals. Preferably, the VSIT software itself is written in Java and operates on any platform that supports a JVM. Alternatively, the VSIT and/or the VTNM may compare data to other patients, if so desired.

In summary of the preferred VSIT method, the VSIT method permits extraction of specific patient vital sign statistics from the server 104 for storing specific vital patient state information within an electronic patient record (EPR). The VSIT method reads a vital signs file (*.vsf, wherein (the *.vsf is differentiated on a patient-by-patient basis) produced by the server 104 based on data provided from the patient monitoring device 102. The administrator of the VSIT method, making use of a specially designed graphical user interface window, selects from any of the parameters available from the server 104. The VSIT method prompts the user for a specific query frequency (i.e., how often the *.vsf file is to be read), and the frequency with which data averaging is performed (i.e., over how many seconds should individuals data samples be accumulated and averaged by the method). The administrator has the option of appending selected data to a repository of the user's choice or over-writing this file. The administrator specifies the name of the host and the port for communicating with the listening server 104 and clicks “go” to start the process. The data are written to several files, including a raw data file, a statistics file, and an alarm file providing the values of the latest severity codes associated with the particular patient. Each file contains the patient name, identification number, bed number, and unit number appended to the parameter name, parameter value, and associated logical observation identifiers names and codes (LOINC) and/or medical information bus/ Committee for European Normalization (MIB/CEN) codes and units and time stamp of the data element. In a preferred scenario envisioned as part of the workflow from a server 104 to a clinical access server 108, these data can be read by the server 104 and sent to the clinical access database on the clinical access server 108. The data are transformed into a format required for storage within the clinical access database where they are available for retrieval by clinical access clients.

In summary of the preferred VTNM, the VTNM transmits data from the patient monitoring device 102 to the electronic patient record (EPR) on the clinical access server 108. The VTNM sends data on an exception basis to the EPR with exceptions being administrator-defined significant changes in specific vital parameters. The changes in vital parameters are measured in accord with a threshold parameter that can be altered by the administrator in real-time at any time. The purpose of the threshold parameter is to enable increased or decreased sensitivity in parameter value variations with respect to statistically significant variations in patient vital parameters. The VTNM exists as an adjunct method to the VSIT method, and may be physically located either on the server 104 or on the clinical access web/application server.

Hence, the VTNM reduces the frequency and quantity of data transmitted to the EPR by the server 104. The server 104 creates vital signs data on as many patients as are actively connected via the server's network (e.g., as many as 64, presently). These data are written periodically to the Infinity Gateway Server as frequently as one vital signs report every 15 seconds. These data must be culled for specific parameters that are desired by clinicians. The quantity and frequency of data are typically less than available or required for a critical care network. However, providing clinicians with information that is time-stamped and stored on the basis of events (e.g., resulting from changes or events, such as observation values from the patient that deviate from the norm or changes in clinical monitoring devices, such as mechanical ventilators) enables clinicians to access a complete record of patient care, without requiring them to sort through vast quantities of raw data. Hence, the VTNM accomplishes this goal by sending only those parameters of specific need to a clinician retrieving data through the system. Furthermore, since data are filtered from their original quantities (e.g., possibly several hundred parameters with observations every fifteen seconds on each patient) to a specific subset of values (e.g., perhaps half a dozen), and because they are transmitted relatively infrequently to the EPR, this facilitates viewing of the patient data via a clinical access server over a low-speed network (e.g., perhaps a telephone line).

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A distribution system for patient medical parameters, comprising:
a communication interface for acquiring patient parameters in a first data format from patient monitoring devices attached to a plurality of different patients, said patient parameters being acquired at a user selectable acquisition receiving interval;
a data processor using said communication interface for filtering acquired patient parameters for an individual patient to identify patient parameters meeting predetermined filtering criteria determinable by a user for,
(a) an individual parameter type, and
(b) an individual patient, and excluding other patient parameters; and
an output processor for converting said filtered identified parameters in said first data format to a different second data format and using said communication interface for output communication of said filtered identified patient parameters together with a parameter time and date of acquisition indication in said second data format.

2. A system according to claim 1, wherein
said second data format is a Health Level Seven (HL7) compatible data format and said communication interface automatically selects at least one of, (a) communication protocol and (b) destination port, in processing said filtered identified parameters in said first data format for output communication.

3. A system according to claim 1, including
a generator for generating data representing at least one displayed user interface image supporting user selection of,
(i) a particular patient parameter type,
(ii) an associated patient, and
(iii) associated predetermined filtering criteria.

4. A system according to claim 1, wherein
said data processor acquires patient parameters at a user selectable acquisition receiving interval selectable by a user for,
(i) an individual parameter type, and
(ii) an individual patient.

5. A system according to claim 1, wherein
said output processor uses said communication interface to communicate said filtered identified patient parameters together with a parameter time and date of acquisition indication and associated predetermined filter criteria in said second data format to a storage file associated with at least one of, (a) a patient electronic record, (b) an alarm file, (c) a raw data file and (d) a statistic compilation file.

6. A system according to claim 5, wherein
said output processor communicates data to said storage file based on identified data type.

7. A system according to claim 1, wherein
said output processor communicates data to a selected storage file in response to user storage file type selection command made via a displayed user interface image.

8. A system according to claim 1, wherein
said output processor communicates data to said storage file for at least one of, (a) overwriting of existing data in said storage file, and (b) adding to existing data in said storage file in response to user command.

9. A system according to claim 1, wherein
said output processor uses said communication interface for output communication of said filtered identified patient parameters together with appended data including at least one of, (a) a patient identifier, (b) a patient bed identifier, (c) a hospital unit identifier, (d) a parameter name, (e) a parameter type, (f) and an associated medical condition code set identifier.

10. A system according to claim 1, wherein
said individual parameter type includes at least one of, (a) heart rate, (b) respiratory rate, (c) blood oxygen saturation indicator, (d) ventilation related data indicator and (e) anatomical electrical activity indicator.

11. A system according to claim 1, wherein
said data processor adaptively averages values of an acquired patient parameter for an individual patient.

12. A system according to claim 1, wherein
said data processor adaptively averages values of an acquired patient parameter for an individual patient in response to user selection of a desired number of values over which said parameter is to be averaged.

13. A system for providing a user interface supporting selectively storing patient parameters in a patient medical record, comprising:
a generator for generating data representing at least one displayed user interface image supporting user selection of,
(i) a particular patient parameter type,
(ii) an associated patient, and
(iii) an associated patient parameter acquisition interval;
a data processor for acquiring patient parameters in a first data format based on said particular patient parameter type, associated patient and associated patient parameter acquisition interval; and
an output processor for converting said acquired patient parameters in said first data format to a different second data format for output communication of said acquired patient parameters together with a parameter time and date of acquisition indication in said second data format.

14. A system according to claim 13, wherein
said data processor adaptively averages values of an acquired patient parameter for an individual patient to provide an average value and
for a patient parameter of said particular parameter type,
said at least one displayed user interface image supports user selection of a user determined number of values of said particular parameter to be used in computing a mean value.

15. A system according to claim 14, wherein
said data processor adaptively averages values of an acquired patient parameter by computing at least one of, (a) a rolling average and (b) a block average.

16. A system for selectively distributing patient parameters, comprising:
a user interface command processor for receiving commands entered via at least one displayed user interface image supporting user selection of,
(i) a particular patient parameter type,
(ii) an associated patient, and
(iii) an associated patient parameter acquisition interval;
a data processor for acquiring patient parameters in a first data format based on said particular patient parameter type, associated patient and associated patient parameter acquisition interval; and
an output processor for converting said acquired patient parameters in said first data format to a different second data format for output communication of said acquired patient parameters together with a parameter time and date of acquisition indication in said second data format.

17. A method for distributing patient medical parameters, comprising the steps of:
acquiring patient parameters in a first data format from patient monitoring devices attached to a plurality of different patients, said patient parameters being acquired at a user selectable acquisition receiving interval;
filtering acquired patient parameters for an individual patient to identify patient parameters meeting predetermined filtering criteria determinable by a user for,
(a) an individual parameter type, and
(b) an individual patient, and excluding other patient parameters; and
converting said filtered identified parameters in said first data format to a different second data format; and
using said communication interface for output communication of said filtered identified patient parameters together with a parameter time and date of acquisition indication in said second data format.

18. A system for selectively storing patient parameters in a patient medical record, comprising:
a communication interface for receiving patient parameters from patient monitoring devices attached to a plurality of different patients and for bidirectional communicating with a patient medical record repository;
a data processor using said communication interface for filtering acquired patient parameters for an individual patient to identify patient parameters meeting predetermined filtering criteria determinable by a user for,
(a) an individual parameter type, and
(b) an individual patient, and excluding other patient parameters; and
an output processor using said communication interface for communicating said filtered identified patient parameters meeting said predetermined filter criteria, together with a parameter time and date of acquisition indication, for storage in a patient record of said individual patient in said record repository.

19. A system according to claim 18, wherein
for an acquired patient parameter,
said data processor computes a measure representing a function of a difference between a current parameter value and a mean value derived from a user determined number of values preceding said current value and
said data processor identifies whether said current parameter value meets said predetermined filtering criteria based on whether said computed measure exceeds a predetermined user selected threshold value.

20. A system according to claim 19, including
a generator for generating data representing at least one displayed user interface image supporting user selection of,
(i) a particular patient parameter type,
(ii) an associated patient, and
(iii) an associated predetermined user selected threshold value.

21. A system according to claim 19, wherein
said data processor computes said function using a standard deviation value derived from said user determined number of values preceding said current value, and
said data processor identifies whether said current parameter value meets said predetermined filtering criteria based on whether said computed measure exceeds a predetermined user selected threshold value, based on the ratio of the square of the difference between the current parameter value and said mean value normalized by a sample variance.

22. A system according to claim 20, wherein
said generated at least one displayed user interface image supports user selection of said associated predetermined user selected threshold value using a sliding bar with user adjustable slide position.

23. A system according to claim 18, wherein
said data processor acquires patient parameters at a user selectable acquisition receiving interval selectable by a user for,
(i) an individual parameter type, and
(ii) an individual patient.

24. A system according to claim 18, wherein
said data processor filters a current acquired patient parameter value by comparing said current parameter value with a mean value derived from a user determined number of values of said acquired patient parameter preceding said current parameter value.

25. A system according to claim 18, wherein
said data processor filters a current acquired patient parameter value by comparing said current parameter value with a mean value normalized using a standard deviation value derived from a user determined number of values of said acquired patient parameter preceding said current parameter value.

26. A system according to claim 24, wherein
said data processor compares said current parameter value with said mean value using a function involving taking the difference of said current parameter value and said mean value and employing a standard deviation value computed over said user determined number of values of said acquired individual patient parameter preceding said current value.

27. A system according to claim 26, wherein
said function used by said data processor computes a distance measure representing a difference between said current parameter value and said mean value and said data processor identifies whether a current parameter value meets said predetermined filtering criteria based on whether a computed distance measure value exceeds a predetermined user selected threshold value.

28. A system according to claim 18, including
a display processor for initiating display of said filtered identified patient parameters meeting said predetermined criteria to a user in response to user command.

29. A system according to claim 18, wherein
said output processor uses said communication interface for communicating said filtered identified patient parameters meeting said predetermined criteria, together with data indicating said predetermined filter criteria and an associated patient and parameter type identifier, for storage in a patient record of said individual patient in said record repository.

30. A system according to claim 18, wherein
said individual parameter type includes at least one of, (a) heart rate, (b) respiratory rate, (c) blood oxygen saturation indicator, (d) ventilation related data indicator and (e) anatomical electrical activity indicator.

31. A system for providing a user interface supporting selectively storing patient parameters in a patient medical record, comprising:
a generator for generating data representing at least one displayed user interface image supporting user selection of,
(i) a particular patient parameter type,
(ii) an associated patient, and
(iii) an associated predetermined threshold value;
a data processor for filtering acquired patient parameters based on said particular patient parameter type, associated patient and associated predetermined threshold value using predetermined filtering criteria; and
an output processor for communicating said filtered identified patient parameters meeting said predetermined filter criteria, together with a parameter time and date of acquisition indication, for storage in a patient record of said individual patient in said record repository.

32. A system according to claim 31, wherein
said data processor acquires patient parameters at a user selectable acquisition receiving interval selectable by a user for,
(i) an individual parameter type, and
(ii) an individual patient.

33. A User interface system according to claim 31, wherein
said generated at least one displayed user interface image supports user selection of said associated predetermined threshold value using a sliding bar with user adjustable slide position.

34. A system according to claim 31, wherein
for a patient parameter of said particular parameter type,
said at least one displayed user interface image supports user selection of a user determined number of values preceding a current value to be used in computing a mean value.

35. A system according to claim 34, wherein
said data processor computes a measure representing a function of a difference between a current parameter value and said mean value and
said data processor identifies whether said current parameter value meets said predetermined filtering criteria based on whether said computed measure exceeds said predetermined user selected threshold value.

36. A system for selectively distributing patient parameters, comprising:
a user interface command processor for receiving commands entered via at least one displayed user interface image supporting user selection of,
(i) a particular patient parameter type,
(ii) an associated patient, and
(iii) an associated predetermined threshold value;
a data processor for filtering acquired patient parameters based on said particular patient parameter type, associated patient and associated predetermined threshold value using predetermined filtering criteria; and
an output processor using said communication interface for communicating and distributing said filtered identified patient parameters meeting said predetermined filter criteria, together with a parameter time and date of acquisition indication.

37. A method for selectively storing patient parameters in a patient medical record, comprising the steps of:
receiving patient parameters from patient monitoring devices attached to a plurality of different patients and for bidirectionally communicating with a patient medical record repository;
filtering acquired patient parameters for an individual patient to identify patient parameters meeting predetermined filtering criteria determinable by a user for,
(a) an individual parameter type, and
(b) an individual patient, and excluding other patient parameters; and
communicating said filtered identified patient parameters meeting said predetermined filter criteria, together with a parameter time and date of acquisition indication, for storage in a patient record of said individual patient in said record repository.
